(19) United States
(12) Patent Application Publication
(10) Pub. No.: US 2026/0212312 A1
(43) Pub. Date: Jul. 23, 2026

(54) LOGISTICS SUPPORT SYSTEM AND LOGISTICS SUPPORT METHOD

(71) Applicant: Hitachi, Ltd., Tokyo (JP)

(72) Inventors: Noriyuki HAGA, Tokyo (JP); Tetsuro ADACHI, Tokyo (JP); Satoshi NAGAHARA, Tokyo (JP)

(21) Appl. No.: 19/424,774

(22) Filed: Dec. 18, 2025

(30) Foreign Application Priority Data
Jan. 20, 2025 (JP) 2025-007930

(51) Int. Cl. G06Q 10/083; G06Q 10/0631

(52) U.S. Cl. CPC G06Q 10/08355; G06Q 10/06315; G06Q 10/0838

(57) ABSTRACT

Provided is a logistics support system including a processor and a storage device. The storage device is configured to hold logistics order information. The processor is configured to: generate information regarding a route from the origin to the destination; determine, when information regarding a logistics resource to be provided for the information regarding the route is acquired, whether or not the information regarding the logistics resource to be provided matches the route from the origin to the destination; generate, in a case where the information regarding the logistics resource to be provided does not match the route from the origin to the destination, information regarding a new route from the origin to the destination so as to include a route matching the information regarding the logistics resource to be provided; and acquire information regarding a logistics resource to be provided for the generated information regarding the new route.

### CLAIM OF PRIORITY

The present application claims priority from Japanese patent application JP 2025-007930 filed on January 20, 2025, the content of which is hereby incorporated by reference into this application.

### BACKGROUND OF THE INVENTION

### Field of the Invention

The present invention relates to a technology for supporting logistics business.

### Description of the Related Art

As examples of a technology for supporting logistics business, there are technologies described in JP 2018-200588 A and JP 2003-12156 A.

JP 2018-200588 A discloses that “a logistics support system that supports delivery of a cargo to be delivered from a sender to a recipient includes: a delivery request reception module that receives a cargo delivery request input by the sender or the recipient and records the cargo delivery request in a delivery request database (DB); a delivery cooperation reception module that receives a delivery cooperation offer input by one or more delivery partners and records the delivery cooperation offer in a delivery cooperation DB; a matching processing module that combines one or more delivery cooperations for the delivery request and records delivery schedule information in a delivery status DB; and a delivery status management module that acquires information regarding reception and delivery of the cargo by each delivery partner and records the information in the delivery status DB”.

JP 2003-12156 A describes that “a cooperative logistics support system using the Internet includes a shipper terminal device having a web browser, a carrier terminal device having a web browser, and a web server. The web server receives an application for a cooperative transport and delivery case for a cargo from a shipper via the Internet, creates a cooperative transport and delivery operation plan that satisfies a condition regarding optimum loading efficiency and the shortest delivery course set in advance based on the application for the cooperative transport and delivery case, discloses the cooperative transport and delivery operation plan on the Internet, receives bids for the cooperative transport and delivery operation plan from carriers via the Internet, presents a bid status on the Internet, and receives an order from the shipper to the carrier via the Internet”.

### SUMMARY OF THE INVENTION

Hitherto, a shipper searches for and requests a necessary logistics resource when making a logistics request. A transport company, a warehouse company, and the like provide the logistics resource itself and information regarding the logistics resource. The transport company provides a truck, a driver, and the like as the logistics resources. The warehouse company provides cargo loading and unloading work (cargo handling) and temporary storage as the logistics resources. Here, a company that provides either or both of transport and warehouse is referred to as a logistics company. The logistics company sets a transport route and a relay point in response to a request from a shipper, and searches for a necessary logistics resource. There is also a case where a logistics matching company participates as a specialized company that searches for such logistics resources and proposes a combination thereof.

Here, although there are a large number of transport routes and available logistics resources, the transport routes and the logistics resources are not necessarily optimal because the transport routes and the logistics resources are searched within a range of experience. In addition, the logistics company may hold a capability that has not been provided in the past as the logistics resource, but there is no mechanism for the logistics company to propose such a capability.

JP 2018-200588 A describes matching between a cargo delivery request from a sender or a recipient and delivery cooperation provided by delivery partners. However, since the matching is performed within a range of the delivery cooperation registered in advance, the matching is not established in a case where the ranges of the delivery cooperation and the delivery request do not overlap each other.

JP 2003-12156 A describes that an application for cooperative cargo transport and delivery is received from a shipper, and bids for a cooperative transport and delivery operation plan are received from carriers. However, there is no description about re-adjustment of the plan and re-bidding in the case of a shortage of resources that have been bid for.

In order to solve at least one of the above-mentioned problems, the present invention is a logistics support system comprising a processor and a storage device. The storage device is configured to hold logistics order information including at least an origin and a destination of a cargo to be transported. The processor is configured to: generate information regarding a route from the origin to the destination; determine, when information regarding a logistics resource to be provided for the information regarding the route is acquired, whether or not the information regarding the logistics resource to be provided matches the route from the origin to the destination; generate, in a case where the information regarding the logistics resource to be provided does not match the route from the origin to the destination, information regarding a new route from the origin to the destination so as to include a route matching the information regarding the logistics resource to be provided; and acquire information regarding a logistics resource to be provided for the generated information regarding the new route.

According to an aspect of the present invention, optimum utilization of a logistics resource is supported.

Problems, configurations, and effects other than those described above will be clarified by the following description of embodiments.

### BRIEF DESCRIPTION OF THE DRAWINGS

FIG. 1 is a block diagram illustrating an example of a configuration of a logistics support system according to an embodiment of the present invention.

FIG. 2 is a block diagram illustrating an example of a hardware configuration for implementing the logistics support system according to the embodiment of the present invention.

FIG. 3 is an explanatory diagram illustrating an example of a logistics order held by the logistics support system according to the embodiment of the present invention.

FIG. 4 is an explanatory diagram illustrating an example of a logistics history data held by the logistics support system according to the embodiment of the present invention.

FIG. 5 is an explanatory diagram illustrating an example of a logistics resource data held by the logistics support system according to the embodiment of the present invention.

FIG. 6 is an explanatory diagram illustrating an example of a re-adjustment condition data held by the logistics support system according to the embodiment of the present invention.

FIG. 7 is an explanatory diagram illustrating an example of a positional relationship of points referred to in the embodiment of the present invention.

FIG. 8 is a flowchart illustrating an example of processing executed by an initial logistics plan generation module of the logistics support system according to the embodiment of the present invention.

FIG. 9 is a flowchart illustrating an example of processing executed by a logistics resource control module of the logistics support system according to the embodiment of the present invention.

FIG. 10 is a flowchart illustrating an example of processing executed by an input agent module of the logistics support system according to the embodiment of the present invention.

FIG. 11 is a flowchart illustrating an example of processing executed by a logistics plan correction module of the logistics support system according to the embodiment of the present invention.

FIG. 12 is a flowchart illustrating an example of the entire processing in the logistics support system according to the embodiment of the present invention.

### DESCRIPTION OF THE PREFERRED EMBODIMENTS

Hereinafter, embodiments of the present invention will be described with reference to the drawings.

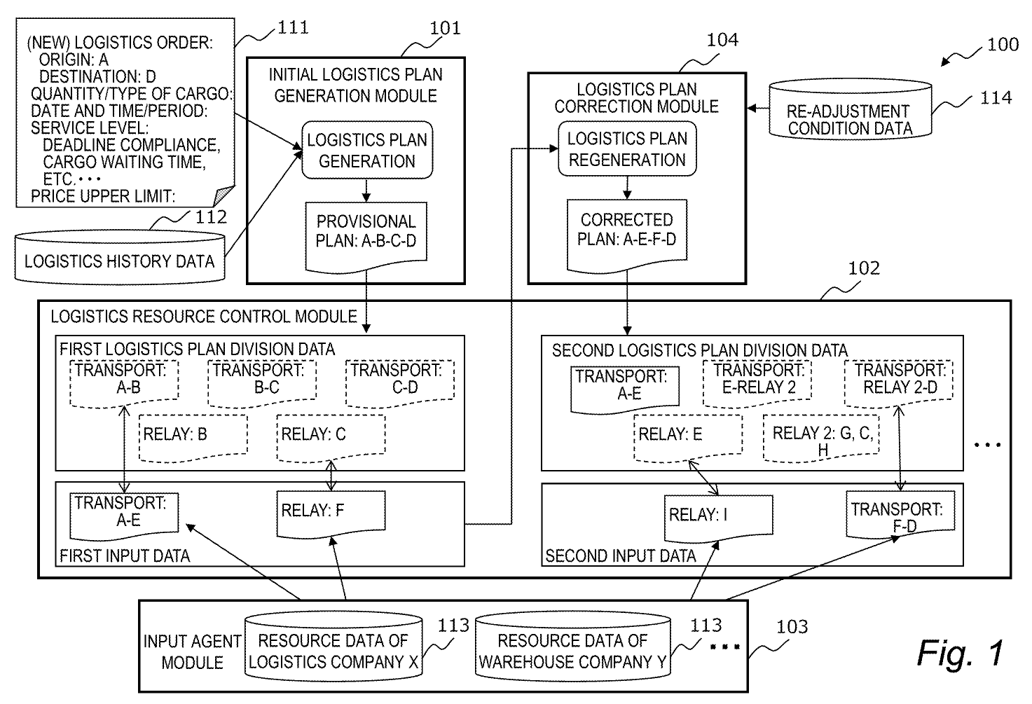

FIG. 1 is a block diagram illustrating an example of a configuration of a logistics support system according to an embodiment of the present invention.

A logistics support system 100 of the present embodiment includes an initial logistics plan generation module 101, a logistics resource control module 102, an input agent module 103, and a logistics plan correction module 104. The initial logistics plan generation module 101 executes logistics plan generation processing based on a logistics order 111 and logistics history data 112, generates an initial logistics plan, and outputs the initial logistics plan to the logistics resource control module 102. The logistics resource control module 102 presents, to the input agent module 103, first logistics plan division data obtained by dividing the initial logistics plan acquired from the initial logistics plan generation module 101 into a plurality of resources. The input agent module 103 transmits, as a response, first input data corresponding to the resources included in the presented logistics plan division data to the logistics resource control module 102 by referring to logistics resource data 113 indicating a resource that can be provided by each logistics company.

Thereafter, the logistics plan correction module 104 determines whether or not it is necessary to correct the initial logistics plan based on the first input data. At this time, re-adjustment condition data 114 may be referred to as a determination condition. In a case where it is necessary to correct the initial logistics plan, the logistics plan correction module 104 executes logistics plan regeneration processing, generates a corrected logistics plan, and outputs the corrected logistics plan to the logistics resource control module 102. The logistics resource control module 102 generates second logistics plan division data by dividing the corrected logistics plan acquired from the logistics plan correction module 104 into a plurality of resources, and presents the second logistics plan division data to the input agent module 103. The input agent module 103 transmits, as a response, second input data corresponding to the resources included in the presented logistics plan division data to the logistics resource control module 102 by referring to the logistics resource data 113.

Thereafter, the determination of the necessity of correction by the logistics plan correction module 104, the generation of the corrected logistics plan when necessary, and the response by the input agent module 103 are repeatedly performed. In a case where it is determined that it is not necessary to correct the initial logistics plan, the current logistics plan is output as a final logistics plan.

Details of the processing in each module and the data referred to in each processing are described below.

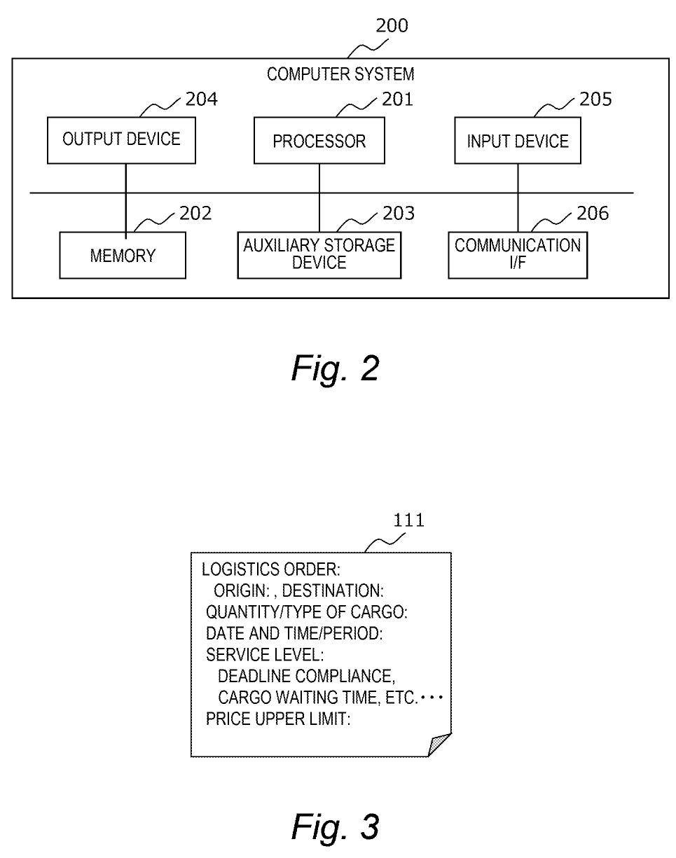

FIG. 2 is a block diagram illustrating an example of a hardware configuration for implementing the logistics support system 100 according to the embodiment of the present invention.

The logistics support system 100 of the present embodiment illustrated in FIG. 1 can be implemented by a computer system. FIG. 2 illustrates a computer system 200 as an example.

The computer system 200 includes a processor 201, a memory (main storage device) 202, an auxiliary storage device 203, an output device 204, an input device 205, and a communication interface (I/F) 206. The above components are connected to each other by a bus. The memory 202 and the auxiliary storage device 203 are storage devices, and store a program and data used by the processor 201.

The memory 202 is implemented by, for example, a semiconductor memory, and is mainly used to hold a program being executed and data. For example, the program and data stored in the auxiliary storage device 203 are loaded into the memory 202 at the time of startup or when necessary. The processor 201 executes various types of processing according to the program stored in the memory 202. The processor 201 operates according to the program, thereby implementing various functional modules (such as the initial logistics plan generation module 101, the logistics resource control module 102, the input agent module 103, and the logistics plan correction module 104 illustrated in FIG. 1).

The auxiliary storage device 203 is implemented by, for example, a large-capacity storage device such as a hard disk drive or a solid state drive, and is used to hold a program and data for a long period of time. For example, the logistics order 111, the logistics history data 112, the logistics resource data 113, the re-adjustment condition data 114, and the like may be held in the auxiliary storage device 203.

Although not illustrated in FIG. 1, road network information or the like for performing a transport route search may be held in the auxiliary storage device 203. In the present embodiment, a route search based on generally known road network information can be applied, and thus detailed description thereof will be omitted.

The processor 201 can be implemented by a single processing unit or multiple processing units, and can include a single arithmetic unit or multiple arithmetic units, or multiple processing cores. The processor 201 can be implemented as one or more central processing units, microprocessors, microcomputers, microcontrollers, digital signal processors, state machines, logic circuits, graphics processing units, chip-on-system, and/or any device that operates a signal based on a control instruction.

The input device 205 is a hardware device for a user to input an instruction, information, and the like. The output device 204 is a hardware device that presents various images for input and output, and is, for example, a display device or a printing device. The communication I/F 206 is an interface for connection to a communication network (not illustrated). For example, the logistics support system 100 may acquire the logistics order 111 from a shipper company via the communication network connected to the communication I/F 206, may acquire the logistics resource data 113 from each logistics company, or may output the generated logistics plan to the logistics company and the shipper company.

The computer system 200 may include two or more processors 201. In addition, functions of the logistics support system 100 can be implemented in a plurality of computer systems 200. In this case, the plurality of computer systems 200 communicate via the communication network. For example, some of the plurality of functions of the system of the present embodiment may be implemented in one computer system 200, and the others may be implemented in another computer system 200.

For example, the computer system 200 may be a personal computer (PC) owned by the user (for example, any logistics company or logistics matching company) of the logistics support system 100 of the present embodiment, or may be a server or the like accessed by the user via the communication network. In the latter case, the computer system 200 may be a virtual server or the like on a so-called cloud. In this case, the computer system 200 illustrated in FIG. 1 is implemented by a computer resource on the cloud.

FIG. 3 is an explanatory diagram illustrating an example of the logistics order 111 held by the logistics support system 100 according to the embodiment of the present invention.

The logistics order 111 is input to the logistics support system 100 from, for example, the shipper company, and is held in the logistics support system 100. The logistics order 111 includes, for example, information such as an origin, a destination, a quantity, and a type of a cargo, a departure and arrival date and time, a period, a service level, and a price upper limit. The information regarding the service level may include, for example, information such as the degree of strictness in deadline compliance (in other words, a length of an allowable delivery delay) and a length of an allowable cargo waiting time.

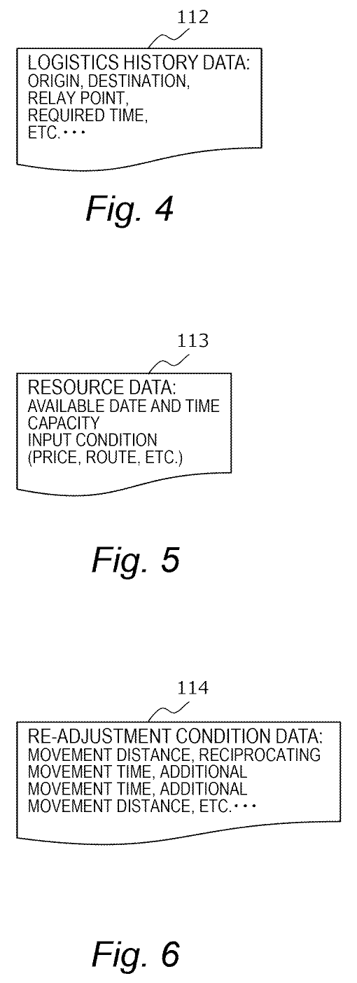

FIG. 4 is an explanatory diagram illustrating an example of the logistics history data 112 held by the logistics support system 100 according to the embodiment of the present invention.

The logistics history data 112 is information regarding the past logistics history of the logistics company, and is collected from, for example, each logistics company and held in the logistics support system 100. The logistics history data 112 may include, for example, information such as an origin, a destination, a relay point, and a required time of past cargo transport.

FIG. 5 is an explanatory diagram illustrating an example of the logistics resource data 113 held by the logistics support system 100 according to the embodiment of the present invention.

The logistics resource data 113 includes information regarding a logistics resource owned by each logistics company. For example, the logistics resource data 113 may be acquired from each logistics company and held in the logistics support system 100, and may be updated at an appropriate timing when the resource of each logistics company changes. The logistics resource data 113 includes, for example, information regarding an (currently) available resource owned by each logistics company.

For example, if a truck and a driver thereof are available, the logistics resource data 113 may include information such as a loading capacity of the truck, a type of cargo that can be loaded, and an area where the truck can travel. In addition, in a case where a truck for which a cargo to be loaded, an origin, a destination, a travel date and time, and the like have already been determined still has a remaining loading capacity and can load other cargos together, the logistics resource data 113 may include information such as the loading capacity, the origin, the destination, the travel date and time, and the like. In addition, in a case where there is a base having a warehouse, a warehouse worker, and the like, which can be used as the relay point for temporarily storing or transshipping the cargo, the logistics resource data 113 may include information regarding the base. In addition, the logistics resource data 113 may include information such as an acceptable condition and an amount of money.

FIG. 6 is an explanatory diagram illustrating an example of the re-adjustment condition data 114 held by the logistics support system 100 according to the embodiment of the present invention.

The re-adjustment condition data 114 is referred to to compare data input from the input agent module 103 with the logistics plan output by the logistics resource control module 102 to thereby determine whether or not regeneration of the logistics plan is necessary. For example, the re-adjustment condition data 114 may include at least one of an upper limit of a movement distance, an upper limit of a reciprocating movement time, an upper limit of an additional movement distance, an upper limit of an additional movement time, and the like.

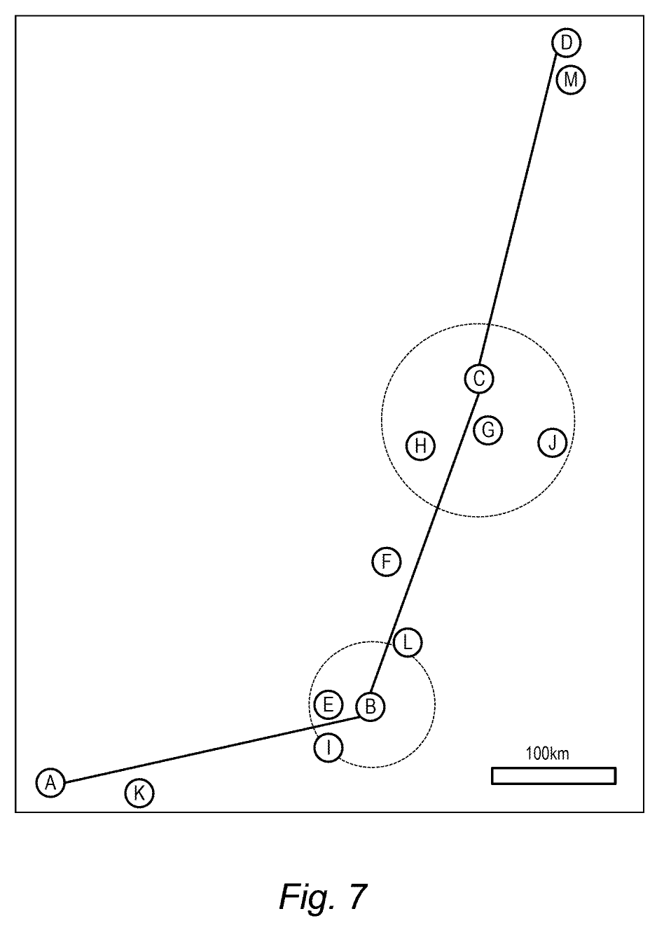

FIG. 7 is an explanatory diagram illustrating an example of a positional relationship of points referred to in the embodiment of the present invention.

FIG. 7 illustrates an example of a positional relationship from a point A to a point M. Each point is, for example, a place where the cargo is received or delivered from the shipper company, a logistics base such as the warehouse, or the like.

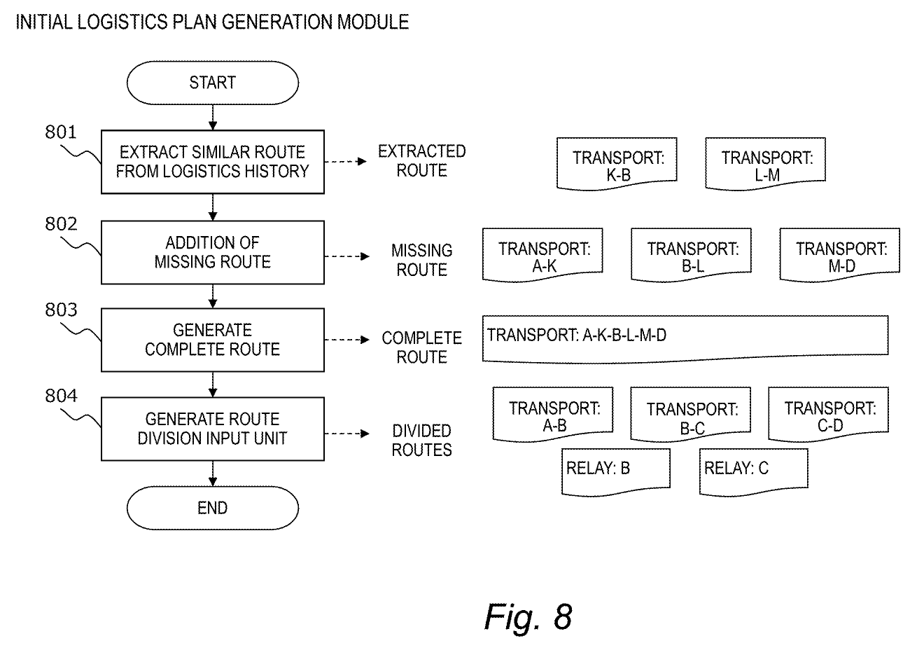

FIG. 8 is a flowchart illustrating an example of processing executed by the initial logistics plan generation module 101 of the logistics support system 100 according to the embodiment of the present invention.

When the new logistics order 111 is input from the shipper company to the logistics support system 100, the initial logistics plan generation module 101 executes the logistics plan generation processing illustrated in FIG. 8. Specifically, first, the initial logistics plan generation module 101 extracts, based on the logistics history data 112, a route along which a cargo has been transported in the past and which is similar to a route from the origin to the destination of the logistics order 111 (step 801).

Next, the initial logistics plan generation module 101 compares the route extracted in step 801 with the route from the origin to the destination of the logistics order 111, and extracts a difference therebetween as a missing route (step 802).

Next, the initial logistics plan generation module 101 combines the route extracted in step 801 and the missing route extracted in step 802 to generate a complete route from the origin to the destination (step 803). Then, the initial logistics plan generation module 101 divides the route generated in step 803 according to a predetermined condition, and generates a logistics plan in input units (step 804).

For example, as illustrated in FIG. 1, in a case where the logistics order 111 having the point A as the origin and a point D as the destination is input, the initial logistics plan generation module 101 extracts a route from a point K to a point B and a route from a point L to the point M, along which a cargo has been transported in the past, based on the logistics history data 112 in step 801. Then, in step 802, the initial logistics plan generation module 101 extracts, as the missing routes, a route from the point A to the point K, a route from the point B to the point L, and a route from the point M to the point D.

Then, in step 803, the initial logistics plan generation module 101 generates, as the complete route, a route from the point A to the point D via the points K, B, L, and M. In step 804, the initial logistics plan generation module 101 divides the complete route based on the predetermined condition. Here, examples of the predetermined condition may include a condition such as a round-trip travel time of 10 hours or less and a travel distance of 300 km or less as constraints for a one-day transport. Such a condition is held as the re-adjustment condition data 114, and the initial logistics plan generation module 101 may refer to the condition.

In the example of FIG. 8, the complete route from the point A to the point D is divided into a route from the point A to the point B, a route from the point B to a point C, and a route from the point C to the point D so as to satisfy the above condition. Then, the three divided routes and the point B and the point C serving as the relay points connecting the respective routes are generated as the logistics plan in input units.

In the above processing, the initial logistics plan generation module 101 refers to the logistics history data 112 to generate the complete route from the origin to the destination so as to include a route along which a cargo has been transported in the past (steps 801 to 803), but it is not essential to refer to the logistics history data 112. For example, the initial logistics plan generation module 101 may generate the complete route from the origin to the destination by a general route search method based on the road network information. However, in a case where a route including a portion along which a cargo has been transported is generated by referring to the logistics history data 112 as illustrated in FIG. 8, it can be expected that the logistics resource is more readily provided from the logistics company.

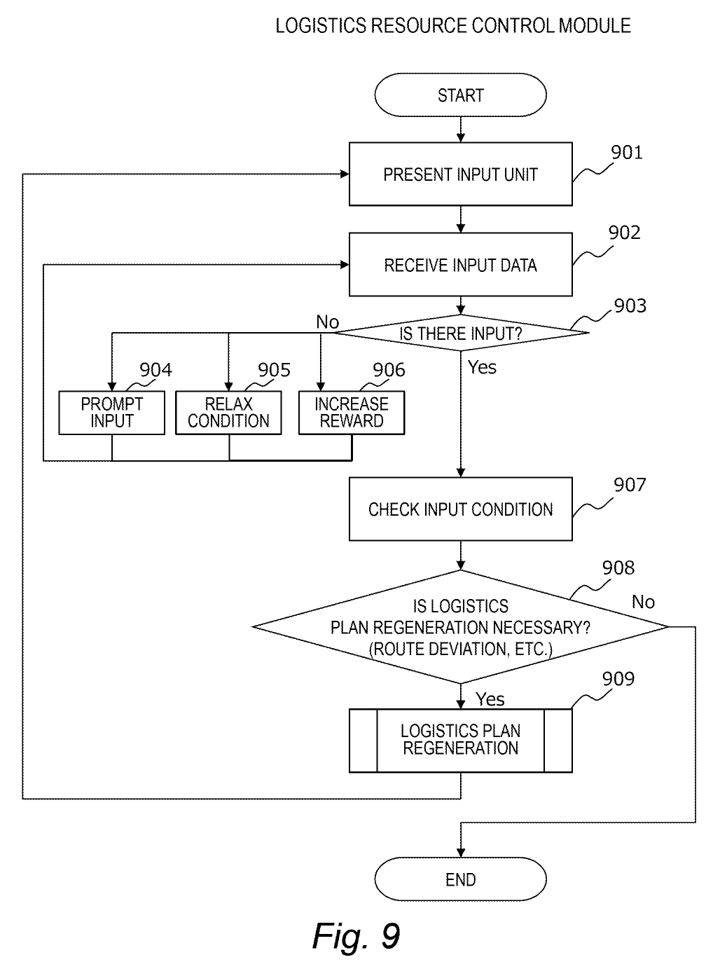

FIG. 9 is a flowchart illustrating an example of processing executed by the logistics resource control module 102 of the logistics support system 100 according to the embodiment of the present invention.

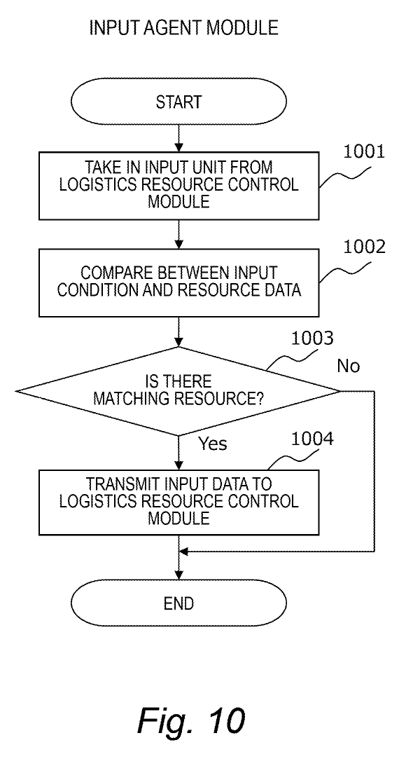

Once the logistics plan is acquired from the initial logistics plan generation module 101 or the logistics plan correction module 104, the logistics resource control module 102 executes the processing illustrated in FIG. 9. Specifically, first, the logistics resource control module 102 presents the acquired logistics plan in input units (step 901). Next, the logistics resource control module 102 receives the input data from the input agent module 103 (step 902). Processing executed by the input agent module 103 at this time is described below (see FIG. 10).

Next, the logistics resource control module 102 determines whether or not there is an input from the input agent module 103 (step 903), and executes a predetermined countermeasure when there is no input (step 903: No). As the countermeasure, for example, at least one of outputting information that prompts input (step 904), relaxing an input condition (step 905), and increasing a fee (step 906) may be performed. Examples of these steps of processing are described below.

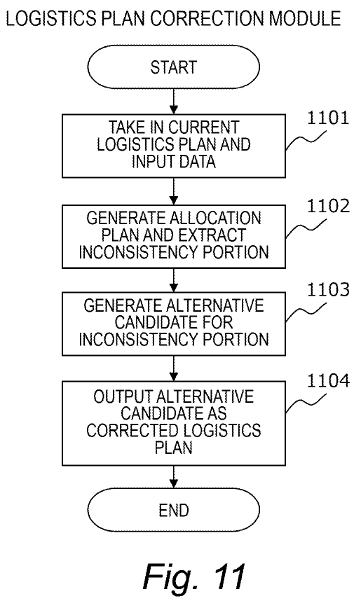

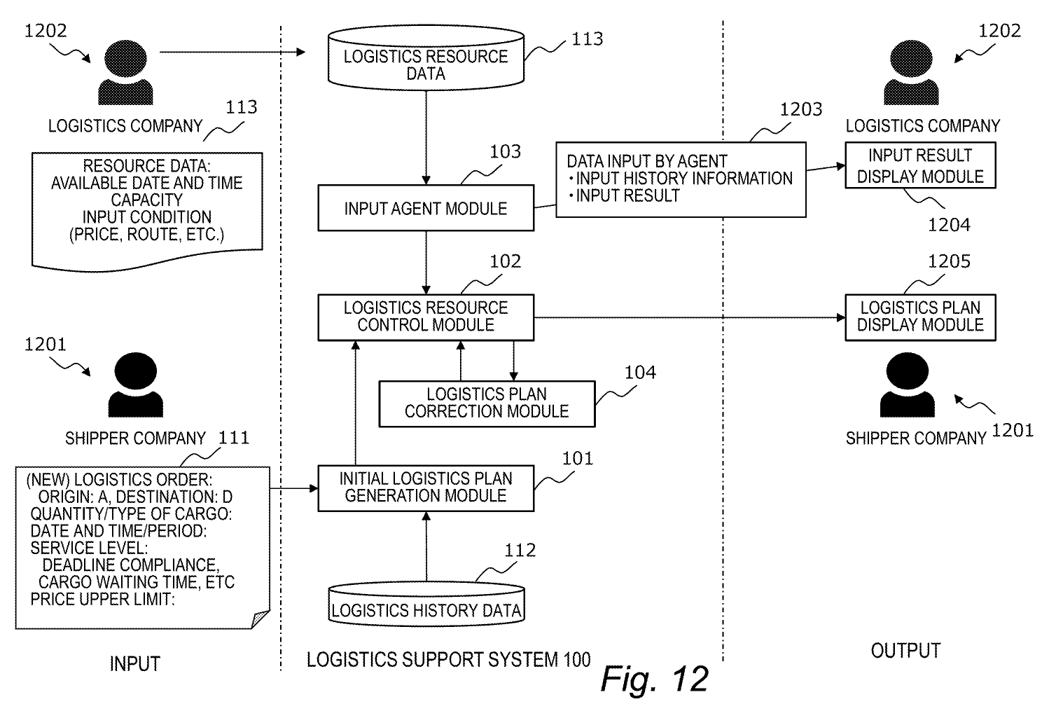

In a case where there is an input from the input agent module 103 (step 903: Yes), the logistics resource control module 102 checks the input condition (step 907) and determines whether or not the logistics plan regeneration is necessary (step 908). In a case where it is determined that the logistics plan regeneration is necessary (step 908: Yes), the logistics resource control module 102 executes the logistics plan regeneration processing (step 909) and returns to step 901. On the other hand, in a case where it is determined that the logistics plan regeneration is not necessary (step 908: No), step 909 is not executed, and the processing ends. The logistics plan regeneration processing executed in step 909 is described below (see FIG. 11).

FIG. 10 is a flowchart illustrating an example of processing executed by the input agent module 103 of the logistics support system 100 according to the embodiment of the present invention.

The input agent module 103 acquires the logistics plan in input units, which is presented by the logistics resource control module 102 in step 901 (step 1001), and compares the logistics plan with the logistics resource data 113 (step 1002). Then, the input agent module 103 determines whether or not there is data matching the acquired logistics plan in the logistics resource data 113 (step 1003).

In a case where there is data matching the acquired logistics plan in the logistics resource data 113 (step 1003: Yes), the input agent module 103 sends the matching data regarding the logistics resource to the logistics resource control module 102 (step 1004), and ends the processing. In step 902, the logistics resource control module 102 receives, as the input data, the data transmitted in step 1004. In a case where there is no data matching the acquired logistics plan in the logistics resource data 113 (step 1003: No), the input agent module 103 ends the processing without executing step 1004.

FIG. 11 is a flowchart illustrating an example of processing executed by the logistics plan correction module 104 of the logistics support system 100 according to the embodiment of the present invention.

First, the logistics plan correction module 104 takes in the current logistics plan (for example, the initial logistics plan or the last corrected logistics plan in a case where the logistics plan has already been corrected one or more times) and the input data for the current logistics plan from the input agent module 103 (step 1101).

Next, the logistics plan correction module 104 generates an allocation plan based on the input data, extracts an inconsistency portion between the created allocation plan and the logistics plan (step 1102), and generates an alternative candidate for the extracted inconsistency portion (step 1103).

Next, the logistics plan correction module 104 outputs the generated alternative candidate to the logistics resource control module 102 as the corrected logistics plan (step 1104).

FIG. 12 is a flowchart illustrating an example of the entire processing in the logistics support system 100 according to the embodiment of the present invention.

The initial logistics plan generation module 101 of the logistics support system 100 acquires the logistics order 111 from a shipper company 1201, generates the initial logistics plan based on the logistics history data 112, and outputs the logistics plan to the logistics resource control module 102. The processing in the initial logistics plan generation module 101 corresponds to the processing illustrated in FIG. 8.

The logistics resource control module 102 presents the logistics plan in input units to the input agent module 103 based on the initial logistics plan. The input agent module 103 determines whether or not there is a logistics resource corresponding to the presented logistics plan in input units by referring to the logistics resource data 113 acquired from a logistics company 1202, and inputs the corresponding logistics resource, if any, to the logistics resource control module 102. The processing in the input agent module 103 corresponds to the processing illustrated in FIG. 10. Although not illustrated in FIG. 12, the input agent module 103 actually holds the logistics resource data 113 acquired from a large number of logistics companies 1202.

The logistics resource control module 102 determines whether or not the logistics plan regeneration is necessary based on the input data from the input agent module 103 and the current logistics plan. In a case where it is determined that the regeneration is necessary, the logistics plan correction module 104 corrects the logistics plan and outputs the result to the logistics resource control module 102. Thereafter, the above processing is repeated until it is determined that the logistics plan regeneration is unnecessary.

In a case where it is determined that the logistics plan regeneration is unnecessary, the logistics resource control module 102 transmits, as the finally determined logistics plan, the current logistics plan to the shipper company 1201. In addition, the input agent module 103 transmits, to the logistics company 1202, the logistics resource input to the logistics resource control module 102 and information 1203 regarding the logistics resource adopted in the finally determined logistics plan. The processing in the logistics plan correction module 104 corresponds to the processing illustrated in FIG. 11, and the series of processing in the logistics resource control module 102 corresponds to the processing illustrated in FIG. 9.

The input agent module 103 may update the logistics resource data 113 such that the logistics resource adopted in the finally determined logistics plan is not provided to the subsequent logistics plan. For example, information regarding the adopted logistics resource may be deleted from the logistics resource data 113, or information indicating that the adopted logistics resource is reserved may be added to the logistics resource data 113.

A logistics plan display module 1205 of the system of the shipper company 1201 outputs the logistics plan transmitted from the logistics resource control module 102 to a person in charge of the shipper company 1201. In addition, an input result display module 1204 of the system of the logistics company 1202 outputs the information 1203 transmitted from the input agent module 103 to the person in charge of the logistics company 1202.

Although detailed description of the system of the shipper company 1201 and the system of the logistics company 1202 is omitted, both can be implemented by, for example, a computer system similar to that illustrated in FIG. 2. For example, each of the input result display module 1204 and the logistics plan display module 1205 may be the output device 204 of the computer system 200 that implements the system of the logistics company 1202 and the system of the shipper company 1201, respectively.

Here, a specific example of the processing described so far will be described. As a specific example, a case where the initial logistics plan generation module 101 generates the logistics plan in input units, which includes the route from the point A to the point B, the route from the point B to the point C, the route from the point C to the point D, and the point B and the point C serving as the relay points as illustrated in FIG. 8 will be described. The logistics plan is presented to the input agent module 103 as the first logistics plan division data illustrated in FIG. 1 (step 901). Although omitted in FIGS. 1 and 8, the logistics plan actually includes information regarding a transport date and time, a type and quantity of a cargo to be transported, an upper limit of a price to be paid, an allowable delivery delay, and the like based on the logistics order 111.

For the initial logistics plan described above, the input agent module 103 inputs, for example, the first input data illustrated in FIG. 1 to the logistics resource control module 102. In the example of FIG. 1, the input agent module 103 inputs, to the logistics resource control module 102, data indicating that the logistics resource for transporting the cargo from the point A to a point E can be provided for the logistics plan in which the cargo is transported along a route from the point A to the point B. Further, the input agent module 103 inputs, to the logistics resource control module 102, data indicating that the logistics resource for performing a relay at a point F can be provided for the logistics plan in which a relay is performed at the point C.

The input of the data indicating the route from the point A to the point E means that, for example, it is determined that the logistics company has a truck that can load the ordered cargo during an ordered time period and travel from the point A to the point E and a driver thereof, based on the logistics resource data 113 of any logistics company (step 1003: Yes). For example, the logistics company may have an empty truck that is not scheduled to travel during the ordered time period, or may have a truck that has already been determined to travel with another cargo loaded during the time period and that can additionally load the ordered cargo and travel from the point A to the point E during the time period.

Similarly, the input of the data indicating the point F as the relay point means that, for example, it is determined that the logistics company has a base (for example, the warehouse) capable of relaying (for example, transshipment between trucks) the ordered cargo during the ordered time period based on the logistics resource data 113 of any logistics company (step 1003: Yes).

In the above processing, the input agent module 103 may compare the presented logistics plan with the logistics resource that can be provided based on the logistics resource data 113 of each logistics company, and in a case where it is determined that the logistics resource satisfying the service level set in the logistics plan can be provided, the input agent module 103 may input data regarding the logistics resource to the logistics resource control module 102. Similarly, in a case where the price set in the presented logistics plan satisfies a price condition set in the logistics resource data 113 of each logistics company, the input agent module 103 may input data regarding the logistics resource to the logistics resource control module 102.

The logistics resource control module 102 receives the input data from the input agent module 103 and checks the input condition (step 902, step 903: Yes, and step 907). For example, the logistics resource control module 102 may determine whether or not the input route from the point A to the point E satisfies the predetermined condition such as the travel distance of 300 km or less and the round-trip travel time of 10 hours or less. In the above example, it is determined that the route from the point A to the point E satisfies the condition.

Then, the logistics resource control module 102 determines whether or not the logistics plan regeneration is necessary (step 908). For example, in a case where the route from the point A to the point E is input for the presented route from the point A to the point B, and the point F is input for the point C that is the presented relay point, but there is no input corresponding to other presented data, the logistics resource for transport from the point E to the point D is not secured. In addition, even if the same data as the presented data is input for the presented route and relay point other than the above, route mismatch occurs.

Specifically, in a case where data other than the above input data is not input, the logistics resource for transport from the point E to the point D is not secured. In addition, even if the point B serving as the relay point, the route from the point B to the point C, and the route from the point C to the point D are input, the logistics resource for transport from the point E to the point B serving as the relay point, and the logistics resource for relaying the route from the point B to the point C and the route from the point C to the point D are not secured. In this case, it is determined that the logistics plan regeneration is necessary (step 908: Yes), and the logistics plan regeneration is performed (step 909).

The logistics plan correction module 104 acquires the current logistics plan and the input data (step 1101). For example, the first logistics plan division data illustrated in FIG. 1 is acquired as the current logistics plan, and the first input data illustrated in FIG. 1 is acquired as the data input correspondingly.

The logistics plan correction module 104 creates the allocation plan based on the current logistics plan and the input data acquired in step 1101, and extracts the inconsistency portion (step 1102). In the above example, the route from the point A to the point E is input for the presented route from the point A to the point B. In this case, inconsistency, in which the point E that is the end point of the input route does not match the point B presented as the relay point to the subsequent route, is extracted. In this case, the logistics plan correction module 104 considers changing the relay point from the point B to the point E.

Specifically, the logistics plan correction module 104 calculates a movement distance and a movement time (for example, a travel distance and a travel time of a truck) on the route from the point A to the point E, which is the presented route, and the route from the point A to the point E, which is indicated by the input data. Then, the logistics plan correction module 104 determines whether or not changing the former route to the latter route satisfies a predetermined condition.

For example, in a case where an additional travel time is limited to two hours or less by the logistics company, the logistics plan correction module 104 determines to change the route when the additional travel time caused by the change from the former route to the latter route is two hours or less, and determines not to change the route when the additional travel time is two hours or more. Here, a case where the additional travel time is two hours or less and it is thus determined to change the route will be described. The above condition is an example, and for example, as described above, a condition that the travel distance is 300 km or less and the round-trip travel time is 10 hours or less may be applied. Such a condition may be acquired, for example, by referring to the re-adjustment condition data 114.

Furthermore, in the above example, inconsistency, in which the point C that is the relay point between the route from the point B to the point C and the route from the point C to the point D, and the point F input as the relay point do not match, is extracted (step 1102). On the other hand, the logistics plan correction module 104 determines whether or not the predetermined condition is satisfied by changing the relay point from the point C to the point F and changing the end point of the previous route and the start point of the subsequent route to the point F accordingly.

For example, the logistics plan correction module 104 determines whether or not the travel distance and the travel time of the route in a case where the start point of the presented route from the point B to the point C is changed from the point B to the point E as described above and the end point is changed from the point C to the point F satisfy the above-described condition. Similarly, the logistics plan correction module 104 determines whether or not the travel distance and the travel time of the route in a case where the start point of the presented route from the point C to the point D is changed from the point C to the point F satisfy the above-described condition.

In the above example, the route from the point E to the point F satisfies the condition, but the route from the point F to the point D does not satisfy the condition. In this case, the change of the relay point from the point C to the point F is rejected.

Then, the logistics plan correction module 104 generates the alternative candidate for the extracted inconsistency portion (step 1103). In the above example, since the condition is satisfied when the relay point is changed from the point B to the point E, the route from the point A to the point E is generated as the alternative candidate for the route from the point A to the point B in the presented logistics plan. In addition, the point E is generated as the alternative candidate for the point B that is the relay point.

On the other hand, since the condition is not satisfied when the relay point is changed from the point C to the point F, and the change is thus rejected, the logistics resource information indicating the point F is excluded from the generation of the alternative candidate. Then, one or more points where both a relationship with the point E and a relationship with the point D satisfy the above-described condition are generated as the alternative candidates for a second relay point. At this time, a point that has been used as the relay point may be selected as the candidate based on the logistics history data 112. In the example of FIG. 1, the points C, G, and H are generated as the alternative candidates for the second relay point. Further, a route from the point E to the second relay point and a route from the second relay point to the point D are generated as the alternative candidates.

The logistics plan correction module 104 outputs, as the corrected logistics plan, the alternative candidate to the logistics resource control module 102 (step 1104). In the example of FIG. 1, the logistics resource control module 102 presents, as the second logistics plan division data, the route from the point A to the point E, the route from the point E to the second relay point, the route from the second relay point to the point D, and the point E and the second relay point serving as the relay points between the routes. As described above, the candidates for the second relay point include the points C, G, and H.

In the example of FIG. 1, the input agent module 103 inputs, to the logistics resource control module 102, data indicating that the logistics resource for performing a relay at a point I can be provided for the logistics plan in which a relay is performed at the point E. Furthermore, the input agent module 103 inputs, to the logistics resource control module 102, data indicating that the logistics resource for transporting the cargo from the point F to the point D can be provided for the logistics plan in which the cargo is transported from the second relay point to the point D.

Thereafter, the checking of a bidding condition (step 907), the determination of necessity of the logistics plan regeneration (step 908), and the logistics plan regeneration processing (steps 909 and 1001 to 1004) are performed in the same procedure as described above. Such processing is repeatedly executed, and the processing ends in a case where it is determined that the logistics plan regeneration is unnecessary (step 908: No). In this case, the logistics plan for which it is determined that the logistics plan regeneration is unnecessary is adopted as the final logistics plan, and the information is reported to the shipper company 1201 and the logistics company 1202 that provides each logistics resource.

For example, although not illustrated in FIG. 1, the logistics resources of a route from the point A to the point I, a route from the point I to the point G, a route from the point G to the point D, and the point I and the point G serving as the relay points between the routes are secured, and in a case where the travel distance, the travel time, and the like between the bases of the respective routes satisfy the above-described condition (step 907), and the logistics resources of all the routes and relay points from the point A to the point D can be secured (step 908: No), the logistics plan including the above-described routes and relay points may be finally adopted.

The input agent module 103 holds the logistics resource data 113 of a large number of logistics companies 1202, and inputs data matching the presented logistics plan to the logistics resource control module 102. Therefore, in the finally adopted logistics plan, the logistics companies 1202 that provide the logistics resources of the respective routes and the respective relay points may be different from each other. As a result, the logistics resource held by each logistics company 1202 can be efficiently used.

As described above, in a case where the logistics resource control module 102 cannot obtain the data input from the input agent module 103 (step 903: No), the logistics resource control module 102 may execute a measure for prompting the input. Specifically, the logistics resource control module 102 may transmit information prompting the input to the logistics company 1202 (step 904). At this time, the logistics resource control module 102 may transmit the information prompting the input to the logistics company 1202 that has provided the logistics resource for transport along a route similar to the route included in the presented logistics plan. In addition, the logistics resource control module 102 may set a condition obtained by relaxing the condition (for example, service-level requirements such as the deadline and the cargo waiting time) set in the logistics order 111 in the logistics plan (step 905), or may set a price exceeding the price upper limit set in the logistics order 111 in the logistics plan (step 906).

In a case where the logistics resource can be allocated to the route from the origin to the destination designated by the logistics order 111 by relaxing the condition or increasing the fee as described above, the logistics resource control module 102 may notify the shipper company 1201 of information regarding the relaxed condition or the increased fee. Alternatively, the logistics order 111 may include conditions such as an upper limit of relaxation of the condition and an upper limit of an increase in fee in advance, and the relaxation or the like may be performed within the range.

In the present embodiment, the logistics support system 100 includes the input agent module 103, but the logistics support system 100 does not have to include the input agent module 103. For example, the system of each logistics company 1202 may include the input agent module 103. In this case, the logistics resource control module 102 needs to disclose the generated logistics plan to each logistics company 1202. In addition, each logistics company 1202 may manually input, to the logistics resource control module 102 of the logistics support system 100, data regarding the logistics resource that can be provided by referring to the disclosed logistics plan without using the input agent module 103.

In addition, the system according to the embodiment of the present invention may be configured as follows.

(1) A logistics support system (for example, the logistics support system 100) includes: a processor (for example, the processor 201); and a storage device (for example, the memory 202 and the auxiliary storage device 203), in which the storage device is configured to hold logistics order information (for example, the logistics order 111) including at least an origin and a destination of a cargo to be transported, and the processor is configured to: generate information regarding a route from the origin to the destination (for example, steps 801 to 804); determine, when information regarding a logistics resource to be provided for the information regarding the route is acquired (for example, steps 902 and 903: Yes), whether or not the information regarding the logistics resource to be provided matches the route from the origin to the destination (for example, step 908); generate, in a case where the information regarding the logistics resource to be provided does not match the route from the origin to the destination (for example, step 908: Yes), information regarding a new route from the origin to the destination so as to include a route matching the information regarding the logistics resource to be provided (for example, steps 909 and 1101 to 1104); and acquire information regarding a logistics resource to be provided for the generated information regarding the new route (for example, step 902).

As a result, in a case where the initial transport route and the logistics resource to be provided from a logistics operator do not match each other, adjustment for making the initial transport route and the logistics resource match each other is automated, so that optimum utilization of the logistics resource is supported.

(2) In the logistics support system according to (1), the processor is configured to: divide the route from the origin to the destination based on a predetermined condition (for example, the re-adjustment condition data 114); and generate, as information regarding the route, information regarding a plurality of divided routes and a relay point between the plurality of routes (for example, step 804), the information regarding the logistics resource to be provided includes information regarding a logistics resource for transporting the cargo along at least a part of the route from the origin to the destination and information regarding a logistics resource for relaying the cargo, and the processor is configured to: determine, in a case where the information regarding the logistics resource to be provided is insufficient for a logistics resource necessary for transporting and relaying the cargo from the origin to the destination, that the information regarding the logistics resource to be provided does not match the route from the origin to the destination (for example, step 908: Yes); and generate the new route from the origin to the destination so as to include a route to which the logistics resource is allocated based on the information regarding the logistics resource to be provided, a route in which the logistics resource is insufficient based on the information regarding the logistics resource to be provided, and a relay point between the routes, in the route from the origin to the destination (for example, steps 909 and 1101 to 1104). In the example described with reference to FIGS. 1, 9, and 11, in a case where the provision of the logistics resource for transporting a cargo from the point A to the point E is input for the transport route from the point A to the point B included in a first logistics plan, the transport route from the point A to the point E (the route to which the logistics resource is allocated based on the information regarding the logistics resource to be provided), the transport route ahead of the point E, and the point E (the route in which the logistics resource is insufficient based on the information regarding the logistics resource to be provided, and the relay point between the routes) serving as the relay point between the routes are newly generated as the second logistics plan.

As a result, in a case where the generated transport route and the logistics resource to be provided from the logistics operator do not match each other, the adjustment for making the generated transport route and the logistics resource to be provided match each other is automated.

(3) In the logistics support system according to (2), the processor is configured to: determine whether or not the route to which the logistics resource is allocated satisfies the predetermined condition based on the information regarding the logistics resource to be provided (for example, step 907); generate, in a case where the route to which the logistics resource is allocated based on the information regarding the logistics resource to be provided satisfies the predetermined condition, the new route from the origin to the destination so as to include the route to which the logistics resource is allocated based on the information regarding the logistics resource to be provided, the route in which the logistics resource is insufficient based on the information regarding the logistics resource to be provided, and the relay point between the routes in the route from the origin to the destination (for example, steps 909 and 1101 to 1104); and exclude, in a case where at least a part of the route to which the logistics resource is allocated based on the information regarding the logistics resource to be provided does not satisfy the predetermined condition, information regarding the logistics resource corresponding to the part that does not satisfy the predetermined condition, and generate the new route from the origin to the destination so as to include the route to which the logistics resource is allocated based on the information regarding the logistics resource to be provided, the route in which the logistics resource is insufficient based on the information regarding the logistics resource to be provided, and the relay point between the routes in the route from the origin to the destination (for example, steps 909 and 1101 to 1104).

As a result, the route is adjusted so as to satisfy a preset condition such as the upper limit of the movement distance and the upper limit of the movement time.

(4) In the logistics support system according to (3), the predetermined condition includes at least one of an upper limit of a movement distance and an upper limit of a movement time.

As a result, for example, the upper limit of the movement distance, the upper limit of the movement time, and the like can be set in advance as the conditions to be satisfied by the route.

(5) In the logistics support system according to (2), the storage device is configured to further hold logistics resource information (for example, the logistics resource data 113) including information regarding a logistics resource providable by a logistics operator, and the processor is configured to acquire, in a case where the logistics resource information includes information regarding a logistics resource providable for at least one of transport and relay on the route, the information regarding the logistics resource by referring to the information regarding the route and the logistics resource information.

As a result, it is possible to determine the provision of the logistics resource in the logistics support system.

(6) In the logistics support system according to (1), the storage device is configured to further hold logistics history information (for example, the logistics history data 112) including information regarding a route along which a cargo has been transported by a logistics operator, and the processor is configured to generate the information regarding the route from the origin to the destination so as to include the route along which a cargo has been transported by the logistics operator (for example, steps 801 to 803).

As a result, it is possible to generate a route for which the logistics operator can easily provide the logistics resource.

(7) In the logistics support system according to (6), information prompting the logistics operator who has transported a cargo along at least a part of the route from the origin to the destination or a route similar to the route from the origin to the destination to provide a logistics resource is output in a case where the information regarding the logistics resource to be provided is not acquired for the information regarding the route (for example, step 904).

As a result, it is possible to prompt the provision of the logistics resource.

(8) In the logistics support system according to (1), the logistics order information includes information regarding a fee for transporting the cargo, and the fee is increased in a case where the information regarding the logistics resource to be provided is not acquired for the information regarding the route (for example, step 906).

As a result, it is possible to prompt the provision of the logistics resource.

(9) In the logistics support system according to (1), the logistics order information includes information regarding a service level required for transporting the cargo, and the required service level is relaxed in a case where the information regarding the logistics resource to be provided is not acquired for the information regarding the route (for example, step 905).

As a result, it is possible to prompt the provision of the logistics resource.

(10) In the logistics support system according to (9), the service level includes at least one of a deadline and a cargo waiting time.

As a result, it is possible to prompt the provision of the logistics resource.

The present invention is not limited to the above-described embodiments, and includes various modified examples. For example, the above-described embodiments have been described in detail for better understanding of the present invention, and are not necessarily limited to those having all the configurations of the description. In addition, a part of the configuration of a certain embodiment can be replaced with a configuration of another embodiment, and a configuration of a certain embodiment can be added to a configuration of another embodiment. In addition, a part of the configuration of each embodiment can be added with another configuration, deleted, or replaced with another configuration.

In addition, some or all of the above-described configurations, functions, processing units, processing means, and the like may be implemented by hardware, for example, by designing with an integrated circuit. In addition, each of the above-described configurations, functions, and the like may be implemented by software by a processor interpreting and executing a program for implementing each function. Information such as a program, a table, and a file for implementing each function can be stored in a storage device such as a nonvolatile semiconductor memory, a hard disk drive, and a solid state drive (SSD), or a computer-readable non-transitory data storage medium such as an integrated circuit (IC) card, a secure digital (SD) card, and a digital versatile disc (DVD).

In addition, the control lines and the information lines indicate what is considered to be necessary for the description, and do not necessarily indicate all the control lines and the information lines on the product. In practice, it may be considered that almost all the configurations are connected to each other.

What is claimed is:

1. A logistics support system comprising:
a processor; and
a storage device, wherein
the storage device is configured to hold logistics order information including at least an origin and a destination of a cargo to be transported, and
the processor is configured to:
generate information regarding a route from the origin to the destination;
determine, when information regarding a logistics resource to be provided for the information regarding the route is acquired, whether or not the information regarding the logistics resource to be provided matches the route from the origin to the destination;
generate, in a case where the information regarding the logistics resource to be provided does not match the route from the origin to the destination, information regarding a new route from the origin to the destination so as to include a route matching the information regarding the logistics resource to be provided; and
acquire information regarding a logistics resource to be provided for the generated information regarding the new route.

2. The logistics support system according to claim 1, wherein
the processor is configured to:
divide the route from the origin to the destination based on a predetermined condition; and
generate, as information regarding the route, information regarding a plurality of divided routes and a relay point between the plurality of routes,
the information regarding the logistics resource to be provided includes information regarding a logistics resource for transporting the cargo along at least a part of the route from the origin to the destination and information regarding a logistics resource for relaying the cargo, and
the processor is configured to:
determine, in a case where the information regarding the logistics resource to be provided is insufficient for a logistics resource necessary for transporting and relaying the cargo from the origin to the destination, that the information regarding the logistics resource to be provided does not match the route from the origin to the destination; and
generate the new route from the origin to the destination so as to include a route to which the logistics resource is allocated based on the information regarding the logistics resource to be provided, a route in which the logistics resource is insufficient based on the information regarding the logistics resource to be provided, and a relay point between the routes, in the route from the origin to the destination.

3. The logistics support system according to claim 2, wherein
the processor is configured to:
determine whether or not the route to which the logistics resource is allocated satisfies the predetermined condition based on the information regarding the logistics resource to be provided;
generate, in a case where the route to which the logistics resource is allocated based on the information regarding the logistics resource to be provided satisfies the predetermined condition, the new route from the origin to the destination so as to include the route to which the logistics resource is allocated based on the information regarding the logistics resource to be provided, the route in which the logistics resource is insufficient based on the information regarding the logistics resource to be provided, and the relay point between the routes in the route from the origin to the destination; and
exclude, in a case where at least a part of the route to which the logistics resource is allocated based on the information regarding the logistics resource to be provided does not satisfy the predetermined condition, information regarding the logistics resource corresponding to the part that does not satisfy the predetermined condition, and generate the new route from the origin to the destination so as to include the route to which the logistics resource is allocated based on the information regarding the logistics resource to be provided, the route in which the logistics resource is insufficient based on the information regarding the logistics resource to be provided, and the relay point between the routes in the route from the origin to the destination.

4. The logistics support system according to claim 3, wherein the predetermined condition includes at least one of an upper limit of a movement distance and an upper limit of a movement time.

5. The logistics support system according to claim 2, wherein the storage device is configured to further hold logistics resource information including information regarding a logistics resource providable by a logistics operator, and
the processor is configured to acquire, in a case where the logistics resource information includes information regarding a logistics resource providable for at least one of transport and relay on the route, the information regarding the logistics resource by referring to the information regarding the route and the logistics resource information.

6. The logistics support system according to claim 1, wherein
the storage device is configured to further hold logistics history information including information regarding a route along which a cargo has been transported by a logistics operator, and
the processor is configured to generate the information regarding the route from the origin to the destination so as to include the route along which a cargo has been transported by the logistics operator.

7. The logistics support system according to claim 6, wherein information prompting the logistics operator who has transported cargo along at least a part of the route from the origin to the destination or a route similar to the route from the origin to the destination to provide a logistics resource is output in a case where the information regarding the logistics resource to be provided is not acquired for the information regarding the route.

8. The logistics support system according to claim 1, wherein
the logistics order information includes information regarding a fee for transporting the cargo, and
the fee is increased in a case where the information regarding the logistics resource to be provided is not acquired for the information regarding the route.

9. The logistics support system according to claim 1, wherein
the logistics order information includes information regarding a service level required for transporting the cargo, and
the required service level is relaxed in a case where the information regarding the logistics resource to be provided is not acquired for the information regarding the route.

10. The logistics support system according to claim 9, wherein the service level includes at least one of a deadline and a cargo waiting time.

11. A logistics support method executed by a computer system including a processor and a storage device that holds logistics order information including at least an origin and a destination of a cargo to be transported, the logistics support method comprising:
generating, by the processor, information regarding a route from the origin to the destination;
determining, by the processor, when information regarding a logistics resource to be provided for the information regarding the route is acquired, whether or not the information regarding the logistics resource to be provided matches the route from the origin to the destination;
generating, by the processor, in a case where the information regarding the logistics resource to be provided does not match the route from the origin to the destination, information regarding a new route from the origin to the destination so as to include a route matching the information regarding the logistics resource to be provided; and
acquiring, by the processor, information regarding a logistics resource to be provided for the generated information regarding the new route.
